(19) United States
(12) Patent Application Publication
(10) Pub. No.: US 2015/0254648 A1
(43) Pub. Date: Sep. 10, 2015

(54) MANAGED DIGITAL WALLETS

(71) Applicant: BANK OF AMERICA CORPORATION, Charlotte, NC (US)

(72) Inventors: Ricardo John Clements, Stuart, FL (US); Joseph B. Castinado, North Glenn, CO (US); Laura Corinne Bondesen, Charlotte, NC (US)

(73) Assignee: BANK OF AMERICA CORPORATION, Charlotte, NC (US)

(21) Appl. No.: 14/196,816

(22) Filed: Mar. 4, 2014

(51) Int. Cl. G06Q 20/36

(52) U.S. Cl. CPC G06Q 20/367

(57) ABSTRACT

Embodiments of the present invention disclose utilizing a token associated with a payment device to enter into transactions. In some embodiments the token is associated directly with a payment device, while in other embodiments the token may be associated with a digital wallet that is associated with the payment device. Particularly, embodiments of the present invention may create a managed digital wallet for a client. A client may then designate individuals to participate in the wallet as an administrator and/or as a user. The present invention may allow a client to control the purchases of a user of the account using the token through the use of limits. Each of the users associated with the account may be assigned one or more individual tokens to use with the digital wallet to enter into transactions instead of using the actual account information of accounts associated with the digital wallet.

### FIELD

This invention relates generally to the field of improving security for transactions, and more particularly embodiments of the invention relate to using tokens in place of account information in various ways in order to enter into transactions securely.

### BACKGROUND

Entering into transactions using account information leaves an account holder open to potential account misappropriation because the customer's account information is shared between multiple parties (e.g., another user, a merchant, an acquiring financial institution, payment association networks, issuing financial institution, or the like) in order to complete the transaction.

### BRIEF SUMMARY

Embodiments of the present invention address the above needs and/or achieve other advantages by providing apparatuses (e.g., a system, computer program product, and/or other device) and methods that help to enter into transactions using a token in place of actual account information.

Embodiments of the present invention disclose utilizing a token (e.g., a virtual payment instrument, or the like) associated with a payment device (e.g., a personal computer, a laptop, a mobile device, such as a phone, smartphone, tablet, or personal display device, a fob, payment wand, or any other like device) to enter into transactions. In some embodiments the token is associated directly with a payment device, while in other embodiments the token may be associated with a digital wallet that is associated with the payment device. Particularly, embodiments of the present invention may create a managed digital wallet for a client. A client may then designate individuals to participate in the wallet as an administrator (e.g., primary account reasonability for inviting users and setting limits on the use of the digital wallet) and/or as a user (e.g., users are authorized to use the digital wallet). Administrators may be officers, managers, employees, or the like of a business (e.g., employees in an accounting department) that are in charge of business accounts (e.g., corporate card accounts). The users may be employees of the company that have access to one or more accounts of the business. Depending on the employees' position within the company the employees may need the card for different purposes (e.g., sales team for sales expenses, procurement team for business expenses, or the like). In another example, the administrators may be parents and the users may be the children, grandparents, or other dependents of the parents for which the parents would like to control spending. In a further embodiment, the administrator may be a trustee and the users may be the beneficiaries of a trust controlled by the trustee. Regardless of the application, the present invention may allow a business, person, or the like to control the purchases of user of the account (e.g., including the administrators that use the account).

Each of the users may be assigned one or more individual tokens to use with the digital wallet to enter into transactions instead of using the actual account information (e.g., account number, security code, expiration date, account name, or any other account information) of accounts associated with the digital wallet. As such, the users do not utilize the actual account number or other account information to enter into a transaction and instead utilize the tokens to enter into transactions. Moreover, if a token of one particular user becomes compromised (e.g., misappropriated, lost, disclosed without authorization, or the like) instead of having to reissue a new account number and/or account information for all of the users of the account, the issuing financial institution alone, or through the business client or retail client, may only need to replace the token associated with the user who's token has been compromised. This is especially ideal when there are one or more account numbers of accounts associated with a plurality of users that are being used to enter into transaction. As such, instead of having to replace account numbers for all of the users that use the compromised account numbers, only the tokens that were compromised are replaced with new replacement tokens. For example, the compromised tokens are uncoupled from the associated accounts (e.g., from the account information), new replacements tokens are coupled to the associated accounts (e.g., to the account information), and the new replacement tokens (e.g., or a link thereto) are presented to the users for use in future transactions.

The administrators may be able to place limits (e.g., constraints, restrictions, or the like) on the use of the digital wallet, tokens, or the like by the users in order to manage (e.g., control) user transactions. For example, limits may be placed on the use of the accounts, through the tokens or the like, by an employer in order to control purchases made by employees, by a family member in order to control purchase made by other family members or dependents, or by any other primary account owner (e.g., trustee) on users of the account (e.g., beneficiary of the trust).

The limits on the tokens in the digital wallets may be placed in a number of ways. For example, an administrator may place global limits on all of the tokens associated with all of the accounts, account limits on tokens associated with specific accounts, one or more group limits on tokens associated with on one or more groups or sub-groups associated with the customer accounts, or individual user limits on tokens associated with individual users. As such, individual tokens are assigned to individual users, groups of tokens may be associated with one or more groups or sub-groups (e.g., hieratical groups of tokens), the tokens associated with each group or sub-group may also be related to specific accounts or groups of accounts, and all of the tokens may be associated under a global hierarchy. As such, different tiers of limits may be placed on the eventual end use of the tokens. In some embodiments the limits may be specifically associated with the tokens, while in other embodiments the limits may be associated with the hierarchal levels (e.g., global level, account level, group level, sub-group level, individual user level) and/or the tokens.

Embodiments of the invention comprise systems, computer program products and methods for using a token based financial transaction system, whereby individual tokens associated with one or more financial accounts are utilized by a plurality of users. The invention comprises associating the plurality of users with a digital wallet; associating the individual tokens with the one or more financial accounts; associating the individual tokens with each of the plurality of users associated with the digital wallet; storing the individual tokens or a reference to access the individual tokens in the digital wallet of each of the plurality of users in place of one or more account numbers of the one or more financial accounts; grouping the individual users or the individual tokens associated with the plurality of users into groups or sub-groups; and creating one or more limits, wherein the one or more limits comprise one or more global limits for the individual users or the individual tokens, one or more group limits or sub-group limits for the groups or the sub-groups of the individual users or the individual tokens, and one or more individual limits for the individual users or the individual tokens.

In further accord with an embodiment the invention comprises receiving an indication that at least one individual token is used to enter into a transaction; receiving transaction information associated with the transaction; determining if the at least one individual token meets the one or more global limits, the one or more group limits or sub-group limits, and the one or more individual limits based on the transaction information; allowing the transaction if the one or more global limits, the one or more group limits or sub-group limits, and the one or more individual limits are met; and denying the transaction if the one or more global limits, the one or more group limits or sub-group limits, or the one or more individual limits fail to be met.

In another embodiment, the invention comprises creating the digital wallet for a client; and providing the digital wallet to the client for use by the individual users.

In yet another embodiment, the invention comprises associating one or more administrators with the digital wallet to create the one or more limits.

In still another embodiment, the invention comprises identifying a misappropriated token from the one or more individual token; and replacing the misappropriated token with an individual replacement token.

In further accord with an embodiment, the invention comprises storing multiple individual tokens within the digital wallet of at least one of the plurality of individual users; and wherein the at least one of the plurality of individual users may select the individual token from the multiple individual tokens in order to enter into a transaction using an individual account from among the one or more financial accounts.

In another embodiment of the invention, a financial institution stores the associations between the individual tokens, and the one or more financial accounts and the individual users.

In yet another embodiment of the invention, a third party institution stores the associations between the individual tokens, and the one or more financial accounts and the individual users.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a high level process flow for a entering into a transaction using a token, in accordance with one embodiment of the present invention;

FIG. 2 illustrates a high level process flow for a entering into a transaction using a token, in accordance with one embodiment of the present invention;

FIG. 3 illustrates a high level process flow for a entering into a transaction using a token, in accordance with one embodiment of the present invention;

FIG. 4 illustrates a managed digital wallet using multiple tokens, in accordance with one embodiment of the present invention; and

FIG. 5 illustrates a block diagram for a token system environment, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution” or “bank,” one of ordinary skill in the art will appreciate that other embodiments of the invention may involve other businesses or institutions that take the place of or work in conjunction with the financial institution or bank to perform one or more of the processes or steps described herein as being performed by a financial institution or bank. Still in other embodiments of the invention the financial institution or bank described herein may be replaced with other types of businesses or institutions that offer account services to customers.

The present invention relates to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly, or within one or more digital wallets associated with the payment devices. In other embodiments, the tokens may be associated with electronic transactions that are made over the Internet instead of using a physical payment device. Utilizing a token as a payment instrument instead of actual account information, and specifically an account number improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear or are erased, while multi-use tokens may be utilized more than once before they disappear or are erased.

Tokens may be 16-digit numbers like credit, debit, or other like account numbers, may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token in order to represent the user account information (e.g., account number, user name, pin number, or the like). In other embodiments of the invention, the digital wallet may store some or all of the user account information, including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiment this may be the merchant) or another third party that stores the token, and the transaction may be processed accordingly.

Specific tokens, in some embodiments, may be tied to a single user account, but in other embodiments, may be tied to multiple user accounts, as will be described throughout this application. Moreover, the tokens may be associated with a specific digital wallet or multiple digital wallets based on the institutions and accounts with which the tokens may be associated. Moreover, the tokens themselves, or the user accounts, users, digital wallets, or the like associated with the tokens may have limitations that limit the transactions that the users may enter into using the tokens. The limitations may include, limiting the transactions of the user to a single merchant, a group of multiple merchants, merchant categories, single products, a group a products, product categories, transaction amount limits, transaction numbers, geographic locations, or other like limits as is described herein.

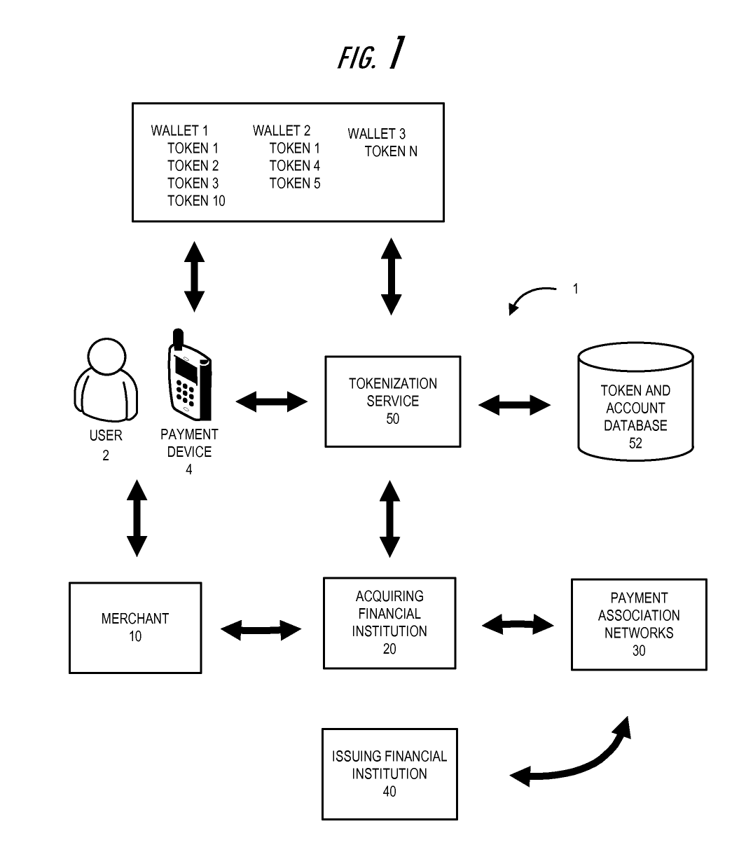

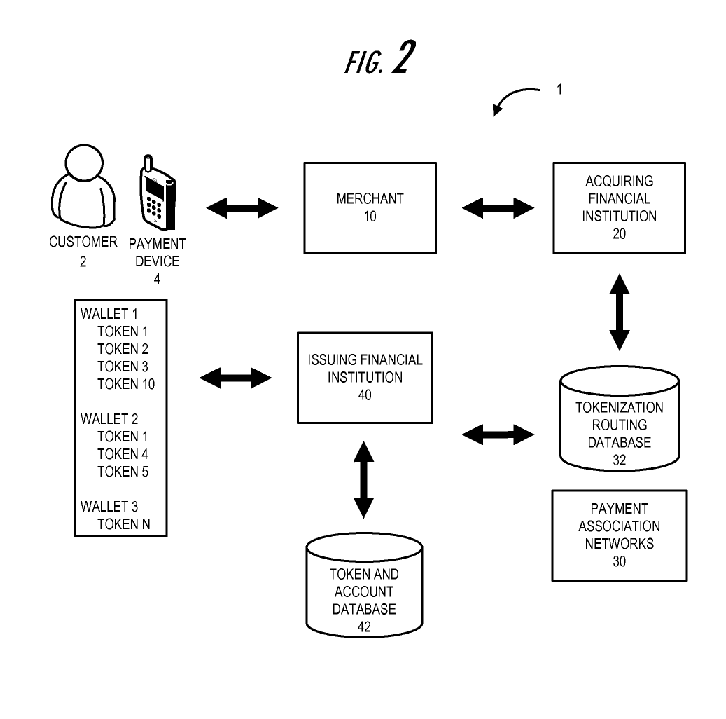

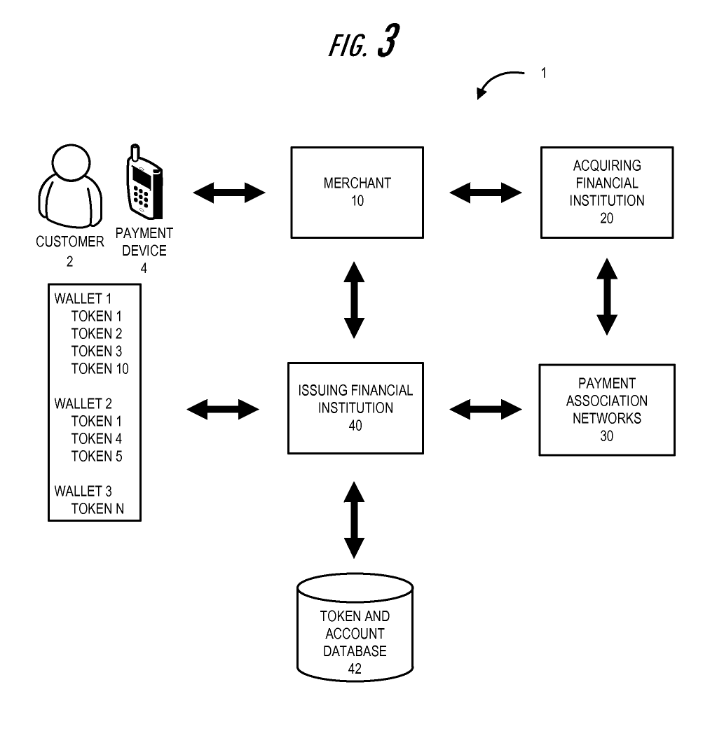

FIGS. 1 through 3 illustrate a number of different ways that the user 2 may use one or more tokens in order to enter into a transaction and make payments associated with the transaction. FIG. 1, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 1 (as well as in FIGS. 2 and 3), a user 2 may utilize a payment device 4 (or in other embodiments a payment instrument over the Internet) to enter into a transaction. FIG. 1 illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like). As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument may be used to enter into the transaction. The payment instrument may be the same as the token or digital wallet associated with the payment device 4, except they are not associated with specific payment device. For example, the token or digital wallet may be associated with an application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 2 with the one or more payment devices 4 may utilize the token. Alternatively, the payment device 4 may have one or more digital wallets stored on the payment device 4 that allow the user 2 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 2 and merchants 10.

As illustrated in FIG. 1, a tokenization service 50 may be available for the user 2 to use during transactions. As such, before entering into a transaction, the user 2 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, or the like) associated with the token that may limit the transactions in which the user 2 may enter. The limits may be placed on the token by the user 2, or another entity (e.g., person, company, or the like) responsible for the transactions entered into by the user 2 using the account associated with the token. The generation of the token may occur at the time of the transaction or well in advance of the transaction, as a one-time use token or multi-use token.

After or during creation of the token the user 2 enters into a transaction with a merchant 10 using the payment device 4 (or payment instrument over the Internet). In some embodiments the user 2 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 2 is entering with the merchant 10.

The merchant 10 submits the token (as well as any user account information not substituted by a token) and the transaction information for authorization along the normal processing channels (also described as processing rails), which are normally used to process a transaction made by the user 2 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described is when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the transaction is allowed), then the acquiring financial institution 20 thereafter sends the user account number, the other user information, and the transaction information directly to the issuing financial institution 40, or otherwise indirectly through the card association networks 30. The financial institution determines if the user 2 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 2 is completed. After the transaction is completed the token may be deleted, erased, or the like if it is a single-use token, or stored for further use if it is a multi-use token.

The embodiment illustrated in FIG. 1 prevents the user account number and other user information from being presented to the merchant 10; however, the tokenization service 50, acquiring financial institution 20, the card association networks 30, and the issuing financial institution 40 all utilize the actual user account number and other user information to complete the transaction.

FIG. 2 illustrates another embodiment of a token system 1, in which the user 2 may utilize a payment device 4 (or payment instrument over the Internet) to enter into transactions with merchants 10 utilizing tokens instead of user account numbers. As illustrated in FIG. 2, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 3). In other embodiments, the issuing financial institution 40 may create the digital wallet for the user 2 (e.g., for through a wallet created for a business client or retail client associated with the user 2) and include one or more tokens for various types of transactions, products, or the like. The issuing financial institution 40 may store the tokens, the associated user account information (e.g., including the user account number), and any limits on the use of the token, as was previously described with respect to the tokenization service 50. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 2 may enter into a transaction with the merchant 10 using a payment device 4 (or a payment instrument through the Internet). In one embodiment the user 2 may enter into the transaction with a token associated with the payment device 4 itself (or a payment instrument through the Internet). In other embodiments, a specific digital wallet and/or a specific account within the digital wallet may be selected for a particular merchant with whom the user 2 wants to enter into a transaction. For example, the user 2 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with tokens and the corresponding issuing financial institutions 40 to which transactions associated with the tokens should be routed.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token or the user account associated with the token. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 2 allows the user and the financial institution to shield the user's account number and other user information from all of the entities in the payment processing system because the merchant 10, acquiring merchant bank 20, payment association networks 30, or other institutions in the payment processing system only used the token and/or other shielded user information to process the transaction. Only the issuing financial institution 40 has the actual account number of the user 2.

FIG. 3 illustrates another embodiment of the token system 1, in which the user 2 may utilize a payment device 4 (or payment instrument over the Internet) to enter into transactions with a merchant 10 utilizing a token instead of a user account number and/or other user account information. As illustrated in FIG. 3, the user 2 may have one or more tokens stored in the payment device 2, which may be associated with one or more digital wallets, or one or more user accounts within the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) and/or the merchant 10 to request a token for the payment device 4, either for the device itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 2 that may be specifically associated with the merchant 10. For example, the issuing financial institution may provide a set of tokens to “merchant 1” to associate with “wallet 1” that may be used by one or more users 2. As such “Token 10” may be associated with “wallet 1” and be specified only for use for transactions with “merchant 1.”

The merchant 10 may provide the specific tokens from the financial institution 40 to the user 2, while the financial institution 40 may store the user account information with the token provided to the user 2. The financial institution may communicate directly with the user 2, or through the merchant 10 in some embodiments, in order to associate the token with the user 2. Since the merchant 10 provides, or is at least notified by the financial institution 40, that a specific token, or groups of tokens, are associated with a specific issuing financial institution 40, then the merchant 10 may associate routing information and transaction information with the token when the user 2 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information directly to the issuing financial institution 40, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 2 that the transaction is allowed or denied.

As is the case with the token system 2 in FIG. 2, the token system in FIG. 3 allows the user 2 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

The embodiments of the invention illustrated in FIGS. 1 through 3 are only example embodiments of the invention, and as such it should be understood that combinations of these embodiments, or other embodiments not specifically described herein may be utilized in order to process transactions between a user 2 and merchant 10 using one or more tokens as a substitute for user account numbers or other user account information, such that the merchant, or even other institutions in the payment processing system do not have access to the actual user accounts or account information.

As briefly discussed above, if the issuing financial institution 40 creates the digital wallet not only does the financial institution 40 receive transaction information along the normal processing channels, but the financial institution 50 may also receive additional transaction information from the user 2 through the digital wallet using the application program interfaces (APIs) or other application created for the digital wallet. For example, geographic location information of the user 2, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 2, the issuing financial institution 40 may not receive all the transaction information from the traditional transaction processing channels or from the digital wallet. As such, the issuing financial institution 40 may have to receive additional transaction information from another application associated with the user 2 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the user enters into transactions using the digital wallets.

Moreover, when there is communication between the digital wallets of the users 2 and the issuing financial institution 40 or another institution, transactions in which the user 2 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 1 through 3.

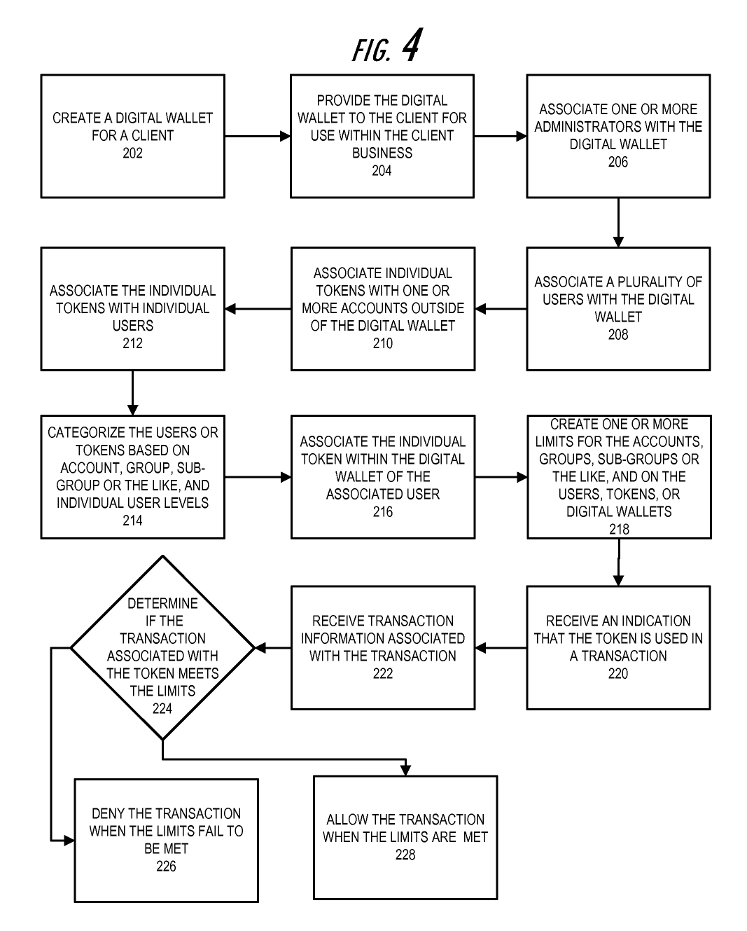

FIG. 4 illustrates a managed digital wallet process 200, in accordance with one embodiment of the invention. As illustrated by block 202 of FIG. 4, an institution may create a digital wallet for use by various clients. In some embodiments, the institution may be the issuing financial institution 40, and the digital wallet may be an application for a client, such as business client (e.g., small, medium, or large business banking customers) to use as a means of controlling the transactions of employee users 2 within the client institution. In other embodiments, the issuing financial institution 40 may create a digital wallet for other clients, such as retail clients (e.g., families, trustees, legal guardians) to use as a means of controlling transactions of the retail users 2 (e.g., kids, grandparents, legal guardians, trust beneficiaries, or the like). In other embodiments, the institution that creates the digital wallet may be a specific merchant 10 (e.g., business, individual user selling products, such as goods and services, or the like) that creates a specific digital wallet for users to utilize during transactions with the specific merchant 10. In other embodiments a tokenization service 50 (e.g., third party application provider) may create the digital wallet for use by a client (e.g., businesses, individual users, or the like). The digital wallet created by the merchant 10 or the tokenization service 50 may be associated with account information from the issuing financial institution 40, which is replaced or substituted with tokens before entering into transactions.

As illustrated by block 204 the institution that creates the digital wallet may provide the digital wallet to the client for eventual use by the user 2. The client may allow specific users 2 to download all or a portion of the digital wallet, access the digital wallet, or otherwise utilize the digital wallet for transactions. In other embodiments of the invention, the digital wallet may not be created specifically for a client, and instead may be a general digital wallet that may be downloaded, accessed, or otherwise utilized by any group of users 2 regardless of whether or not the users 2 are business client, retail clients, or any other type of client.

Block 206 of FIG. 4 illustrates that one or more administrators may be associated with the digital wallet. For example, in the case of a business client, the business client may associate one or more administrators (e.g., officers, managers, or employees of the business) with the digital wallet to set and control the spending of any employee users 2 that are granted access to use the digital wallet for transactions. In the case of a retail client, the retail client may associate one or more administrators (e.g., parents, trustee, legal guardian) with the digital wallet to set and control the spending of any retail users 2 (e.g., kids, or any other dependents) that are granted access to user the mobile wallet. For, example, parents may assign themselves as administrators. The administrators may be responsible for setting limits on the transactions in which the users 2 associated with the digital wallet may enter.

Block 208 of FIG. 4 illustrates that a plurality of users 2 may be associated with the digital wallet. As such, in the case of a business client, the business client or administrators may determine what employee users 2 may download, access, or otherwise utilize the digital wallet to enter into transactions. In other embodiments any of the employee users 2 may be allowed to install (e.g., download, access, or otherwise use) the digital wallet on the user's payment device 4; however, the employee users 2 may only be allowed to use the digital wallet after is associated with an account, for example provided a token. In addition, in the case of a retail client, the retail client or administrator may also determine what retail users 2 may download, access, or otherwise utilize the digital wallet to enter into transactions. Again, the digital wallet may be installed on the retail user's payment device 4, but the retail user 2 may not be able to use the digital wallet until the retail client or administer allows for an account (e.g., token) to be associated with the digital wallet.

As illustrated by block 210, individual tokens are associated with one or more accounts outside of the digital wallet. For example, as discussed with respect to FIGS. 1 through 3 one or more accounts may be coupled to multiple tokens by the issuing financial institution 20, tokenization service 50, or other like institution. As such, in the case of a shared account (e.g., shared by employee user 2 or retail users 2) the shared account may have a plurality of tokens associated with the same account, when then can be distributed to the users 2, as discussed in further detail later. For example, in the case of a business client, a plurality of tokens may be associated with a business account (e.g., a corporate card account) that the employee users 2 may utilize in order to enter into transactions related to the business. In other embodiments of the invention, in the case of a retail client, a plurality of tokens may be associated with an account of the administrator (e.g., parents may associate the tokens with one or more savings, checking, or other like accounts owned by the parents).

Block 212 illustrates that the individual tokens associated with accounts are also associated with individual users 2. For example, a first token associated with a first business account may be also associated with a first employee user 2. A second token associated with a first business account may be associated with a second employee user 2. In addition, a third token associated with a second business account may also be associated with a first employee user 2. As such, the first employee user 2 may be associated with multiple tokens, which may each be associated with individual business accounts (e.g., business account 1 and business account 2, or the like). Alternatively, as discussed with respect to an employee user 2, a retail user 2 may also be associated with one or more tokens that are each associated with one or more separate accounts. For example, a first retail user 2 may be associated with a first token and a second token, wherein the first token is associated with a first retail account (e.g., a debit account) and a second token is associated with a second retail account (e.g., a credit account).

Block 214 illustrates that the users, and thus, the tokens associated with the users are categorized into various accounts, groups, sub-groups, or the like. As such, the tokens and users 2 may not only be associated on an individual level, but may also be associated with other users 2 and groups. For example, the client or administrator may associate individual users 2 with various accounts (e.g., user 1 and user 2 may both be associated with account 1, while user 1 is also associated with account 2). The individual users 2 within an account or across accounts may also be categorized into groups of users 2, such as a first set of users 2 are associated with a first group (e.g., sales group), and a second set of users 2 are associated with a second group (e.g., procurement group). Moreover, individual users 2 within a group may be associated with sub-groups, such as the users in the first group may be further defined into a first sub-group (e.g., sales team 1) and a second sub-group (e.g., sales team 2). The sub-groups may further be divided into additional sub-groups until the individual user level is reached. As such, the users 2 may be structured into hierarchal levels within a business client, in order to place limits on the uses of one or more of the business accounts based on the hierarchal levels.

In addition to the users or in the alternative, the tokens that are associated with the individual users may be categorized into the hierarchal levels described above (e.g., account level, group level, sub-group level, additional sub-groups, an individual level). In one embodiment the tokens are categorized together after they are assigned to the users 2 and as the users 2 are categorized into the various levels. Alternatively, the tokens may be categorized together before the users 2 are categorized, and thus assigned to the users 2, in part, based on the categories to which the tokens are assigned. For example, a set of tokens may be assigned to a specific account and this set of tokens may be further categorized into a first token group. As is the case with the users 2, the first token group may be further divided into a first sub-group, a second sub-group, or the like. Each of the tokens within a sub-group may be further divided into additional sub-groups. As such, the tokens may be categorized and assigned to different accounts, group, sub-groups or the like, and on the individual user level.

By categorizing the tokens and/or the users into the various levels, this may allow the client (e.g., the administrator) to place limits on a global level, account level, group level, sub-group level, or the like, as well as the individual level. For example, a business client can control the transactions of employee users 2 globally, within teams of employees, and/or on individual employees. In another example, this may allow a retail client to set limits on groups of retail users 2 (e.g., kids, trust beneficiaries, grandparents, legal dependents, or the like).

As illustrated by block 216 the tokens may be associated with the digital wallet of each of the associated users 2. For example, in some embodiments the digital wallet of each user 2 may store the token information (e.g., store the actual tokens, store a link to the tokens, or otherwise communicate with a system that stores the tokens) instead of the actual account number or other account information. As discussed, the digital wallet may store the token information for multiple tokens associated with multiple accounts (e.g., multiple business accounts or multiple retail accounts).

Block 218 of FIG. 4 illustrates that one or more limits may be placed on the tokens, users 2, and/or digital wallets. For example, the limits may include the maximum aggregate amount spent using the account, the maximum single transaction amount, number of transactions allowed, geographic restrictions (e.g., specific merchant, area, zip code, city, county, state, country, radius from a specified point, route along one or more roads, or other like geographic location), merchant limits, product limits, or the like. Additional limits may include timeframe limits, such as hourly, time of day, daily, weekly, monthly, or custom timeframes (e.g., every other day, every Saturday, or the like). All of the different types of limits may be approval limits or denial limits, such that for example the limits may include allowing transactions in specific geographic areas and/or for a particular time, or denying transactions in specific geographic areas and/or for a particular time. In other embodiments of the invention the use of a specific token or digital wallet may include the ability to lock, unlock, and/or suspend use the specific token or digital wallet on an as needed basis. For example, the administrator may be able turn on or off the use of the token or digital wallet to allow or prevent transactions.

In some embodiments of the invention, the limits may be placed on the tokens, the users (e.g., the individual users, the sub-group of users, the group of users, or the users associated with an account, or the like), the digital wallets of the users 2, or the actual accounts listed within the digital wallets. For example, when the limits are placed on the token, if the token becomes compromised and replaced with another token, the limits maybe lost or have to be transferred to the new replacement token. As such, in some embodiments when a token is replaced the limits are transferred to the new token, while in other embodiments the limits may have to be reinstated. In other embodiments, the limits may be associated with the individual users, groups of users, sub-groups of users, or the like. This allows the different limits to be placed on the users globally, on multiple users, or on individual users 2 as necessary. As such, in these embodiments when a token is compromised and requires replacement, the limits may not be affected because the limits are not specifically tied to the tokens.

In addition, the limits may be further placed on the digital wallet or individual accounts within the digital wallet. For example, users 2 may utilize a first account and a second account associated with a digital wallet. The users 2 may be within the same sub-groups and groups, but the first account and the second account may have different limits or the same limits. Alternatively, the first account and second account may be associated with different sub-groups and groups, and either have different limits or the same limits. It should be understood that any combination of limits described above might be used to set various limits on different levels described within this application, or on levels not specifically described within this application.

Block 220 of FIG. 4 illustrates that an institution receives an indication that a token is being used in a transaction. Also, as illustrated in block 222, the institution also receives transaction information associated with the transaction. The institution that receives the indication of the transaction and/or the transaction information was previously described with respect to FIGS. 1-3. As such, the institution may be the issuing financial institution 40 or the tokenization service 50 institution, and thus the transaction may be processed as described with respect to FIGS. 1-3, or in other processes not specifically described. In some embodiments, for example when the client stores the limits, the issuing financial institution 50 may access the limits stored at the client, and determine if the transaction should be allow or denied before allowing or denying the transaction. In other embodiments, the digital wallet application being used to enter into the transaction, or the merchant 10, may communicate with the client before passing the transaction on for processing or before allowing or denying the transaction.

As such, as previously discussed with respect to FIGS. 1 through 3, or furthermore with respect to blocks 220 and 222 in FIG. 4, a determination is made to if the transaction associated with the token being used meets the limits, as illustrated by block 224. In one embodiment the highest levels of limits (e.g., global limits) may be asserted first, then the next levels of limits (e.g., account limits, group limits, sub-group limits, or the like) may be asserted next, then the individual user level of limits (e.g., individual user limits, token limits, specific digital wallet limits, or the like) may be asserted in order to determine if the transaction should be allowed or denied. In other embodiments of the invention, the inverse may occur and as such the individual limits may be asserted first, then the sub-group or group limits, the account limits, and finally the global limits. In other embodiments of the invention, the limits may be asserted in any order.

As illustrated by block 226, if the transaction (e.g., transaction information) fails to meet the limits the transaction may be denied. Alternatively, if the transaction (e.g., transaction information) meets the limits then transaction may be allowed, as illustrated by block 228.

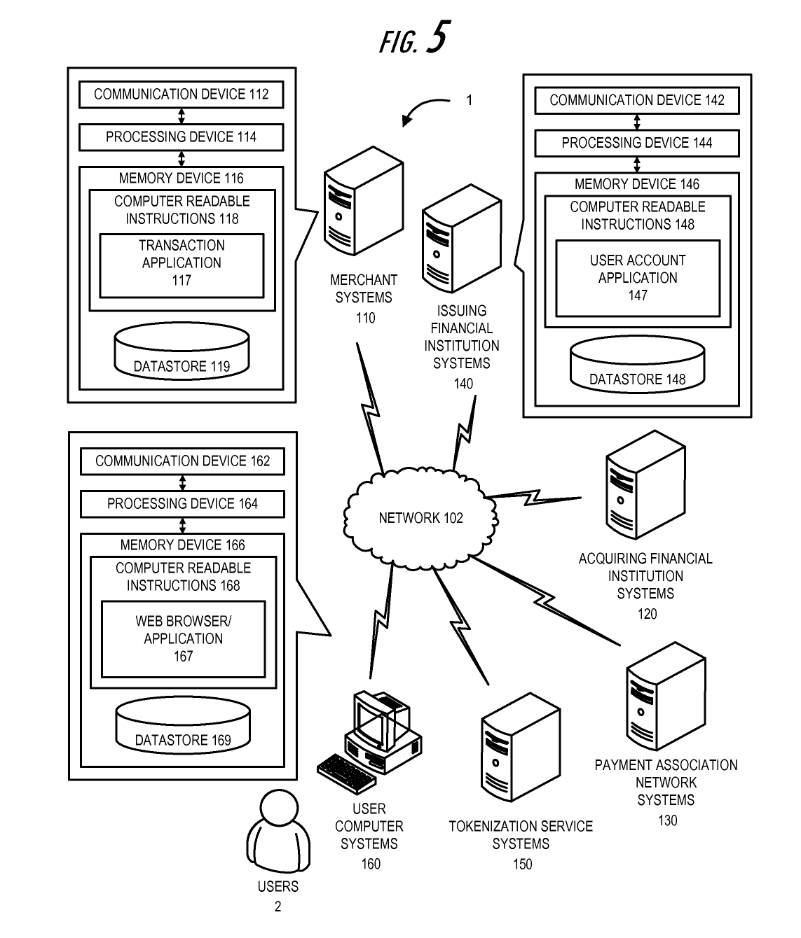

FIG. 5 illustrates a token system 100 environment, in accordance with an embodiment of the present invention. As illustrated in FIG. 5, the user computer systems 160 are operatively coupled, via a network 102 to the merchant systems 110, issuing financial institution systems 140, acquiring financial institution systems 120, payment association networks 130, and/or the tokenization service systems 150. In this way, the user 2 may utilize the user computer systems 160 to enter into secure transactions using a token with the merchant 10 through the use of the merchant systems 110, acquiring financial systems 120, payment association networks 130, the issuing financial institution systems 140, and/or the tokenization service systems 150. FIG. 5 illustrates only one example of embodiments of a token system 100, and it will be appreciated that in other embodiments one or more of the systems (e.g., computers, mobile devices, servers, or other like systems) may be combined into a single system or be made up of multiple systems.

The network 102 may be a global area network (GAN), such as the Internet, a wide area network (WAN), a local area network (LAN), or any other type of network or combination of networks. The network 102 may provide for wireline, wireless, or a combination of wireline and wireless communication between devices on the network.

As illustrated in FIG. 5, the user computer systems 160 generally comprise a communication device 162, a processing device 164, and a memory device 166. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 164 is operatively coupled to the communication device 162 and the memory device 166. The processing device 164 uses the communication device 162 to communicate with the network 102 and other devices on the network 102, such as, but not limited to, the merchant systems 110, issuing financial institution systems 140, acquiring financial institution systems 120, payment association network systems 130, and/or tokenization service systems 150. As such, the communication device 162 generally comprises a modem, server, or other device for communicating with other devices on the network 102, and a display, camera, keypad, mouse, keyboard, microphone, and/or speakers for communicating with one or more users 102. The user computer systems 160 may include, for example, a payment device 4, which may be a personal computer, a laptop, a mobile device (e.g., phone, smartphone, tablet, or personal display device (“PDA”), or the like) or other like devices whether or not the devices are mentioned within this specification. In some embodiments, the user computer systems 160, such as a payment device 4, or other devices, could include a data capture device that is operatively coupled to the communication device, processing device 164, and the memory device 166. The data capture device could include devices such as, but not limited to a location determining device, such as a radio frequency identification (“RFID”) device, a global positioning satellite (“GPS”) device, Wi-Fi triangulation device, or the like, which can be used by a user 2, institution, or the like to capture information from a user 2, such as but not limited to the location of the user 2.

As further illustrated in FIG. 5, the user computer systems 160 comprises computer-readable instructions 168 stored in the memory device 166, which in one embodiment includes the computer-readable instructions 168 of a tokenization application 167 (e.g., a digital wallet or other application that utilizes tokens). In some embodiments, the memory device 166 includes a datastore 169 for storing data related to the user computer system 160, including but not limited to data created and/or used by tokenization application 167. As discussed above the tokenization application 167 allows the users 2 to enter into secure transactions using one or more tokens instead of customer account number or other customer information.

As further illustrated in FIG. 5, the merchant systems 110 generally comprise a communication device 112, a processing device 114, and a memory device 116. The processing device 114 is operatively coupled to the communication device 112 and the memory device 116. The processing device 114 uses the communication device 112 to communicate with the network 102, and other devices on the network 102, such as, but not limited to, the user computer systems 160, issuing financial institution systems 140, acquiring financial institution systems 120, payment association network systems 130, and/or the tokenization service systems 150. As such, the communication device 112 generally comprises a modem, server, or other device(s) for communicating with other devices on the network 102.

As illustrated in FIG. 5, the merchant systems 110 comprise computer-readable program instructions 118 stored in the memory device 116, which in one embodiment includes the computer-readable instructions 118 of a transaction application 117. In some embodiments, the memory device 116 includes a datastore 119 for storing data related to the merchant systems 110, including but not limited to data created and/or used by the transaction application 117. The transaction application 117 processes transactions with the user regardless of whether or not the user is using tokens or the actual account number or other account information.

As further illustrated in FIG. 5, the issuing financial institution systems 140 generally comprise a communication device 142, a processing device 144, and a memory device 146. The processing device 144 is operatively coupled to the communication device 142 and the memory device 146. The processing device 144 uses the communication device 142 to communicate with the network 102, and other devices on the network 102, such as, but not limited to, the user computer systems 160, merchant systems 110, acquiring financial institution systems 120, payment association network systems 130, and/or the tokenization service systems 150. As such, the communication device 142 generally comprises a modem, server, or other devices for communicating with other devices on the network 102.

As illustrated in FIG. 5, the issuing financial institution systems 140 comprise computer-readable program instructions 148 stored in the memory device 146, which in one embodiment includes the computer-readable instructions 148 of a user account application 147. In some embodiments, the memory device 146 includes a datastore 149 for storing data related to the issuing financial institution systems 140, including but not limited to data created and/or used by the user account application 147. The user account application 147 allows the issuing financial institution to store information regarding the user accounts. For example, in the embodiments in which the issuing financial institution 40 is responsible for managing the tokenization, the user account application 147 stores the tokens associated with the account number or the other customer information, which the users 2 utilize to enter into transactions. In other embodiments of the invention, the association of the tokens and accounts numbers and other account information from the issuing financial institution 40 may be stored by a third party.

The acquiring financial institution systems 120 are operatively coupled to the user computer systems 160, merchant systems 110, payment association network systems 130, issuing financial institutions 140, or tokenization service systems 150 through the network 102. The acquiring financial institution systems 120 have devices that are the same as or similar to the devices described for the user computer systems 160, merchant systems 110, or the issuing financial institution systems 140 (e.g., communication device, processing device, memory device with computer-readable instructions, datastore, or the like). Thus, the acquiring financial institution systems 120 communicate with the user computer systems 160, merchant systems 110, payment association network systems 130, issuing financial institution systems 140, and/or the tokenization service systems 150, in the same or similar way as previously described with respect to these systems above. The acquiring financial institution systems 120, in some embodiments, receives the tokens and/or other customer information, along with the transactions information for a transaction, from the merchants 10 and distributes this information to the proper tokenization service 50, payment association networks 30, or directly the issuing financial institution 40.

The payment association network systems 130 are operatively coupled to the user computer systems 160, merchant systems 110, acquiring financial institution systems 120, issuing financial institutions 140, or tokenization service systems 150 through the network 102. The payment association network systems 130 have devices that are the same as or similar to the devices described for the user computer systems 160, merchant systems 110, or the issuing financial institution systems 140 (e.g., communication device, processing device, memory device with computer-readable instructions, datastore, or the like). Thus, the payment association network systems 130 communicate with the user computer systems 160, merchant systems 110, acquiring financial institution systems 120, issuing financial institution systems 140, and/or the tokenization service systems 150, in the same or similar way as previously described with respect to these systems above. The payment association networks systems 130, in some embodiments, receive the tokens and/or other customer information, along with the transactions information for a transaction, from the merchants 10 or the acquiring financial institution 20, and distribute this information to the proper issuing financial institution 40.

The tokenization service systems 150 are operatively coupled to the user computer systems 160, merchant systems 110, acquiring financial institution systems 120, or issuing financial institutions 140 through the network 102. The tokenization service systems 150 have devices the same or similar to the devices described for the user computer systems 160, merchant systems 110, or the issuing financial institution systems 140 (e.g., communication device, processing device, memory device with computer-readable instructions, datastore, or the like). Thus, the tokenization service systems 150 communicate with the user computer systems 160, merchant systems 110, acquiring financial institution systems 120, and/or issuing financial institution systems 140, in the same or similar way as previously described with respect to the these systems above. The tokenization service systems 150, in some embodiments, create, associate, and store the tokens, account numbers, and/or other customer information in order to shield the account numbers or other customer account information from the merchants 10, and other parties as described throughout this specification. In some embodiments as illustrated in FIG. 1, the tokenization service systems 150 may be operated by a third party entity. In other embodiments the tokenization service systems 150 may be operated by the issuing financial institution 40 or entity associated with the issuing financial institution 40, such that only the issuing financial institution 40 has access to the actual account number or other account information.

It is understood that the systems and devices described herein illustrate one embodiment of the invention. It is further understood that one or more of the systems, devices, or the like can be combined or separated in other embodiments and still function in the same or similar way as the embodiments described herein.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

To supplement the present disclosure, this application further incorporates entirely by reference the following commonly assigned patent applications:

| | U.S. Pat- | | |
|---|---|---|---|
| | ent Appli- | | |
| | cation | | |
| Docket Number | Ser. No. | Title | Filed On |
| 6071US1.014033.2153 | | TOKEN | Concurrently |
| | | COLLABORATION | Herewith |
| | | NETWORK | |
| 6071US2.014033.2154 | | FORMATION AND | Concurrently |
| | | FUNDING OF A | Herewith |
| | | SHARED TOKEN | |
| 6072US1.014033.2151 | | LIMITING TOKEN | Concurrently |
| | | COLLABORATION | Herewith |
| | | NETWORK USAGE | |
| | | BY USER | |
| 6072US2.014033.2152 | | LIMITING TOKEN | Concurrently |
| | | COLLABORATION | Herewith |
| | | NETWORK USAGE | |
| | | BY TOKEN | |
| 6073US1.014033.2149 | | LIMITING THE | Concurrently |
| | | USE OF A TOKEN | Herewith |
| | | BASED ON A | |
| | | USER LOCATION | |
| 6073US2.014033.2150 | | AUTHORIZING | Concurrently |
| | | A TEMPORARY | Herewith |
| | | TOKEN FOR | |
| | | A USER | |
| 6074US1.014033.2148 | | CONTROLLING | Concurrently |
| | | TOKEN ISSUANCE | Herewith |
| | | BASED ON | |
| | | EXPOSURE | |
| 6075US1.014033.2146 | | FLEXIBLE | Concurrently |
| | | FUNDING | Herewith |
| | | ACCOUNT TOKEN | |
| | | ASSOCIATIONS | |
| 6075US2.014033.2147 | | ACCOUNT TOKEN | Concurrently |
| | | ASSOCIATIONS | Herewith |
| | | BASED ON | |
| | | SPENDING | |
| | | THRESHOLDS | |
| 6076US1.014033.2144 | | ONLINE BANKING | Concurrently |
| | | DIGITAL WALLET | Herewith |
| | | MANAGEMENT | |
| 6076US2.014033.2145 | | CUSTOMER TOKEN | Concurrently |
| | | PREFERENCES | Herewith |
| | | INTERFACE | |
| 6076US3.014033.2172 | | CREDENTIAL | Concurrently |
| | | PAYMENT | Herewith |
| | | OBLIGATION | |
| | | VISIBILITY | |
| 6077US1.014033.2143 | | PROVIDING | Concurrently |
| | | SUPPLEMENTAL | Herewith |
| | | ACCOUNT | |
| | | INFORMATION IN | |
| | | DIGITAL WALLETS | |
| 6078US1.014033.2142 | | PROVIDING | Concurrently |
| | | OFFERS | Herewith |
| | | ASSOCIATED WITH | |
| | | PAYMENT | |
| | | CREDENTIALS IN | |
| | | DIGITAL WALLETS | |
| 6078US2.014033.2179 | | PROVIDING | Concurrently |
| | | OFFERS | Herewith |
| | | ASSOCIATED WITH | |
| | | PAYMENT | |
| | | CREDENTIALS | |
| | | AUTHENTICATED | |
| | | IN A SPECIFIC | |
| | | DIGITAL WALLET | |
| 6079US1.014033.2141 | | FOREIGN | Concurrently |
| | | EXCHANGE | Herewith |
| | | TOKEN | |
| 6079US2.014033.2173 | | FOREIGN CROSS- | Concurrently |
| | | ISSUED TOKEN | Herewith |
| 6080US1.014033.2140 | | DIGITAL WALLET | Concurrently |
| | | EXPOSURE | Herewith |
| | | REDUCTION | |
| 6080US2.014033.2174 | | MOBILE DEVICE | Concurrently |
| | | CREDENTIAL | Herewith |
| | | EXPOSURE | |
| | | REDUCTION | |
| 6081US1.014033.2139 | | ATM TOKEN CASH | Concurrently |
| | | WITHDRAWAL | Herewith |
| 014033.002194 | | RESTORING OR | Concurrently |
| | | REISSUING OF A | Herewith |
| | | TOKEN BASED | |
| | | ON USER | |
| | | AUTHENTICATION | |
| 014033.002195 | | TOKEN USAGE | Concurrently |
| | | SCALING BASED | Herewith |
| | | ON DETERMINED | |
| | | LEVEL OF | |
| | | EXPOSURE | |

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for use in a token based financial transaction system, whereby individual tokens associated with one or more financial accounts are utilized by a plurality of users, the system comprising:
a memory device; and
a processing device operatively coupled to the memory device, wherein the processing device is configured to execute computer-readable program code to:
associate the plurality of users with a digital wallet, wherein at least a portion of the digital wallet is stored on a payment device for each of the plurality of users;
associate the individual tokens with the one or more financial accounts;
associate each of the individual tokens with each of the plurality of users associated with the digital wallet;
store each of the individual tokens, or a reference to access each of the individual tokens, in the digital wallet of each of the plurality of users in place of one or more account numbers of the one or more financial accounts, wherein each of the individual tokens or the reference is stored on the payment device for each of the plurality of users;
group each of the individual users or each of the individual tokens associated with each of the plurality of users into one or more groups or sub-groups and
create one or more limits, wherein the one or more limits comprise one or more global limits associated with each of the one or more financial accounts for each of the individual users or the individual tokens associated with the one or more financial accounts, one or more group limits or sub-group limits associated with each of the one or more groups or sub-groups for each of the individual users or the individual tokens associated with each of the one or more groups or the sub-groups, and one or more individual limits associated with each of the individual users or the individual tokens,
wherein for each of the individual tokens, a single individual token is associated with a global financial account from the one or more financial accounts, a single user from the plurality of users, and at least one of the one or more groups or the sub-groups;
wherein the associations between the individual tokens, the one or more financial accounts, the plurality of users, and the one or more groups or sub-groups are stored by a tokenization system or by financial institution systems;
identify a compromised token from the individual tokens;
determine the single user, the global financial account, and the at least one of the one or more groups or the sub-groups associated with the compromised token;
replace the compromised token in the digital wallet of the user with a replacement individual token, wherein the replacement individual token is associated with the single user, the global financial account, and the at least one of the one or more groups or sub-groups associated with the compromised token.

2. The system of claim 1, wherein the processing device is further configured to execute computer-readable program code to:
receive an indication that at least one individual token is used to enter into a transaction;
receive transaction information associated with the transaction;
determine if the at least one individual token meets the one or more global limits, the one or more group limits or sub-group limits, and the one or more individual limits based on the transaction information;
allow the transaction if the one or more global limits, the one or more group limits or sub-group limits, and the one or more individual limits are met; and
deny the transaction if the one or more global limits, the one or more group limits or sub-group limits, or the one or more individual limits fail to be met.

3. The system of claim 1, wherein the processing device is further configured to execute computer-readable program code to:
create the digital wallet for a client; and
provide the digital wallet to the client for use by the individual users.

4. The system of claim 1, wherein the processing device is further configured to execute computer-readable program code to:
associate one or more administrators with the digital wallet to create the one or more limits.

5. (canceled)

6. The system of claim 1, wherein the processing device is further configured to execute computer-readable program code to:
store multiple individual tokens within the digital wallet of at least one of the plurality of individual users; and
wherein the at least one of the plurality of individual users may select the individual token from the multiple individual tokens in order to enter into a transaction using an individual account from among the one or more financial accounts.

7. The system of claim 1, wherein a financial institution stores the associations between the individual tokens, and the one or more financial accounts and the individual users.

8. The system of claim 1, wherein a third party institution stores the associations between the individual tokens, and the one or more financial accounts and the individual users.

9. A computer program product for use in a token based financial transaction system, whereby individual tokens associated with one or more financial accounts are utilized by a plurality of users, the computer program product comprising at least one non-transitory computer-readable medium having computer-readable program code portions embodied therein, the computer-readable program code portions comprising:
an executable portion configured for associating the plurality of users with a digital wallet, wherein at least a portion of the digital wallet is stored on a payment device for each of the plurality of users;
an executable portion configured for associating the individual tokens with the one or more financial accounts;
an executable portion configured for associating each of the individual tokens with each of the plurality of users associated with the digital wallet;
an executable portion configured for storing each of the individual tokens, or a reference to access each of the individual tokens, in the digital wallet of each of the plurality of users in place of one or more account numbers of the one or more financial accounts, wherein each of the individual tokens or the reference is stored on the payment device for each of the plurality of users;
an executable portion configured for grouping each of the individual users or each of the individual tokens associated with each of the plurality of users into one or more groups or sub-groups; and
an executable portion configured for creating one or more limits, wherein the one or more limits comprise one or more global limits associated with each of the one or more financial accounts for each of the individual users or the individual tokens associated with the one or more financial accounts, one or more group limits or sub-group limits associated with each of the one or more groups or sub-groups for each of the individual users or the individual tokens associated with each of the one or more groups or the sub-groups, and one or more individual limits associated with each of the individual users or the individual tokens;
wherein for each of the individual tokens, a single individual token is associated with a global financial account from the one or more financial accounts, a single user from the plurality of users, and at least one of the one or more groups or the sub-groups;
wherein the associations between the individual tokens, the one or more financial accounts, the plurality of users, and the one or more groups or sub-groups are stored by a tokenization system or by financial institution systems;
an executable portion configured for identifying a compromised token from the individual tokens;
an executable portion configured for determining the single user, the global financial account, and the at least one of the one or more groups or the sub-groups associated with the compromised token; and
an executable portion configured for replacing the compromised token in the digital wallet of the user with a replacement individual token, wherein the replacement individual token is associated with the single user, the global financial account, and the at least one of the one or more groups or sub-groups associated with the compromised token.

10. The computer program product of claim 9, wherein the computer-readable program code portions further comprise:
an executable portion configured for receiving an indication that at least one individual token is used to enter into a transaction;
an executable portion configured for receiving transaction information associated with the transaction;
an executable portion configured for determining if the at least one individual token meets the one or more global limits, the one or more group limits or sub-group limits, and the one or more individual limits based on the transaction information;
an executable portion configured for allowing the transaction if the one or more global limits, the one or more group limits or sub-group limits, and the one or more individual limits are met; and
an executable portion configured for denying the transaction if the one or more global limits, the one or more group limits or sub-group limits, or the one or more individual limits fail to be met.

11. The computer program product of claim 9, wherein the computer-readable program code portions further comprise:
an executable portion configured for creating the digital wallet for a client; and
an executable portion configured for providing the digital wallet to the client for use by the individual users.

12. The computer program product of claim 9, wherein the computer-readable program code portions further comprise:
an executable portion configured for associating one or more administrators with the digital wallet to create the one or more limits.

13. (canceled)

14. The computer program product of claim 9, wherein the computer-readable program code portions further comprise:
an executable portion configured for storing multiple individual tokens within the digital wallet of at least one of the plurality of individual users; and
wherein the at least one of the plurality of individual users may select the individual token from the multiple individual tokens in order to enter into a transaction using an individual account from among the one or more financial accounts.

15. The computer program product of claim 9, wherein a financial institution stores the associations between the individual tokens, and the one or more financial accounts and the individual users.

16. The computer program product of claim 9, wherein a third party institution stores the associations between the individual tokens, and the one or more financial accounts and the individual users.

17. A method for using a token based financial transaction system, whereby individual tokens associated with one or more financial accounts are utilized by a plurality of users, the method comprising:
associating, by one or more processing devices, the plurality of users with a digital wallet, wherein at least a portion of the digital wallet is stored on a payment device for each of the plurality of users;
associating, by the one or more processing devices, the individual tokens with the one or more financial accounts;
associating, by the one or more processing devices, each of the individual tokens with each of the plurality of users associated with the digital wallet;
storing, by the one or more processing devices, each of the individual tokens, or a reference to access each of the individual tokens, in the digital wallet of each of the plurality of users in place of one or more account numbers of the one or more financial accounts, wherein each of the individual tokens or the reference is stored on the payment device for each of the plurality of users;
grouping, by the one or more processing devices, each of the individual users or each of the individual tokens associated with each of the plurality of users into one or more groups or sub-groups; and
creating, the one or more processing devices, one or more limits, wherein the one or more limits comprise one or more global limits associated with each of the one or more financial accounts for each of the individual users or the individual tokens associated with the one or more financial accounts, one or more group limits or sub-group limits associated with each of the one or more groups or sub-groups for each of the individual users or the individual tokens associated with each of the one or more groups or the sub-groups, and one or more individual limits associated with each of the individual users or the individual tokens;
wherein for each of the individual tokens, a single individual token is associated with a global financial account from the one or more financial accounts, a single user from the plurality of users, and at least one of the one or more groups or the sub-groups;
wherein the associations between the individual tokens, the one or more financial accounts, the plurality of users, and the one or more groups or sub-groups are stored by a tokenization system or by financial institution systems;
identifying, by the one or more processing devices, a compromised token from the individual tokens;
determining, by the one or more processing devices, the single user, the global financial account, and the at least one of the one or more groups or the sub-groups associated with the compromised token; and
replacing, the one or more processing devices, the compromised token in the digital wallet of the user with a replacement individual token, wherein the replacement individual token is associated with the single user, the global financial account, and the at least one of the one or more groups or sub-groups associated with the compromised token.

18. The method of claim 17, further comprising:
receiving an indication that at least one individual token is used to enter into a transaction;
receiving transaction information associated with the transaction;
determining if the at least one individual token meets the one or more global limits, the one or more group limits or sub-group limits, and the one or more individual limits based on the transaction information;
allowing the transaction if the one or more global limits, the one or more group limits or sub-group limits, and the one or more individual limits are met; and
denying the transaction if the one or more global limits, the one or more group limits or sub-group limits, or the one or more individual limits fail to be met.

19. The method of claim 17, further comprising:
creating the digital wallet for a client; and
providing the digital wallet to the client for use by the individual users.

20. (canceled)
